(19) United States
(12) Patent Application Publication
(10) Pub. No.: US 2014/0061114 A1
(43) Pub. Date: Mar. 6, 2014

(54) Porous Composite Membrane Including Microporous Membrane Layers And Nanofiber Layer

(71) Applicant: Raul A. Ramirez, Burlington, MA (US)

(72) Inventor: Raul A. Ramirez, Burlington, MA (US)

(21) Appl. No.: 14/114,868

(22) PCT Filed: May 9, 2012
(86) PCT No.: PCT/US12/37031

§ 371 Date: Oct. 30, 2013

Related U.S. Application Data
(60) Provisional application No. 61/483,820, filed on May 9, 2011.

(51) Int. Cl. B01D 69/12

(52) U.S. Cl. CPC B01D 69/12
USPC 210/321.6; 210/489

(57) ABSTRACT

A filtration member comprising a nanofiber layer and two nanoporous membrane layers is disclosed. The filtration member can be used to remove particles and gels from photoresist and other fluids by a combination of sieving and non-sieving particle retention mechanisms.

### RELATED APPLICATIONS

This application claims the benefit of U.S. Provisional Application No. 61/483,820, filed May 9, 2011. The entire teachings of the above application are incorporated herein by reference.

### BACKGROUND OF THE INVENTION

U.S. Pub. No. 2008/0217239, discloses a liquid filter of a composite medium that has a nanoweb adjacent to and optionally bonded to a microporous membrane. The microporous membrane is characterized by an LRV value of 3.7 at a rated particle size, and the nanoweb has a fractional filtration efficiency of greater than 0.95 at the rated particle size of the microporous membrane. According to the disclosure, the nanoweb can be made by electrospinning or electroblowing. According to this disclosure, the composite medium can be used in the form of filter cartridges, in the form of a flat panel or cylindrical unit and can be used in a variety of filtering method applications, such as filtering both gaseous and liquid flows, semiconductor manufacture, and other applications. Examples of polyolefin based microporous films for use as the filtration membrane are described and the specification discloses electroblowing polyamide-6,6 in formic acid to form the nanoweb.

U.S. Pat. No. 7,008,465 discloses a layered filter media that uses a combination of active filtration layers including at least a high efficiency substrate and at least one fine fiber or nanofiber layer to effectively remove dust, dirt and other particulates. Such a substrate type can include HEPA media, fiberglass HEPA, ULPA media, 95% DOP media, melt blown media, electret media, cellulose/meltblown layered media, etc. The nanofiber layer and the high efficiency substrate are selected to obtain a balanced set of properties that permits the user to remove submicron particles efficiently at a relatively low-pressure drop. A high efficiency substrate (either a single layer or a layered substrate structure) has a particulate efficiency exceeding 80% when tested in accordance with ASTM 1215. According to the disclosure the fine fiber of the class of materials can have a diameter of about 0.01 to 5 microns. Such microfibers can have a smooth surface comprising a discrete layer of the additive material or an outer coating of the additive material that is partly solubilized or alloyed in the polymer surface, or both. Materials disclosed for use in the blended polymeric systems are nylon 6; nylon 66; nylon 6-10; nylon (6-66-610) copolymers and other linear generally aliphatic nylon compositions. The fine fibers can be made by electrospinning.

WO 2004/112183, discloses a complex membrane for an electrochemical device such as a lithium secondary battery. The complex membrane includes a micro-porous polyolefin membrane, and a web-phase porous membrane united to at least one side of the micro-porous polyolefin membrane and composed of nanofibers. According to the disclosure, the micro-porous polyolefin membrane is a membrane having at least one layer composed of polyethylene polymer, and the micro-porous polyolefin membrane preferably has a thickness of 5 to 50 microns and a porosity of 30 to 80%. Further, according to this disclosure, the nanofiber preferably has a diameter of 50 to 2,000 nm. The web-phase porous membrane made of nanofibers may be formed on one surface of the micro-porous membranes by directly spinning a polymer solution by means of electrospinning.

Entegris Inc., Japanese Patent Application No. 2008-210063, filed Aug. 18, 2008, discloses and claims a polyamide non-woven fabric manufactured using an electro-spinning method, wherein the fiber diameter is 50 nanometers to 200 nanometers, the 500 mL flow time as defined in the specification is 2-20 seconds, and the 0.144 micron PSL removal rate as defined in the specification is 40-100%. A filter unit having this non-woven fabric is claimed.

JP Publication No. 2007-301436, abstract, discloses an air filter medium that is provided with a sheet-like nanofiber structure layer with which the nanofiber is three-dimensionally entangled, an upstream side porous material layer which integrally overlies the surface of the filtration upstream side of the nanofiber structure layer and a downstream side porous material layer which is integrally laminated on the surface of the filtration downstream side of the nanofiber structure layer. The face which is integrally laminated with the nanofiber structure layer of the upstream side porous material layer and the downstream side porous material layer is flat and smooth with no fluffy projections. The downstream side porous material layer has gas permeability of which the pressure loss is 100 Pa or less at the air flow rate of 1 m/second.

JP Publication No. 2006-326579, abstract, discloses a filter medium that includes a polytetrafluoroethylene (PTFE) porous membrane, an air permeable support material, and a web layer composed of polymer fibers formed by an electrospinning method (charge induction spinning method or electrostatic spinning method). In the filter medium of this invention, an air permeable adhesive layer may be provided adjacent to the web layer. For example, the ranges of the average pore size of the PTFE porous membrane are 0.01 micrometer-5 micrometers. Nylon, polyethylene, and polypropylene electrospun fibers are disclosed.

JP Publication No. 2007-075739, abstract, discloses a filter unit that has a filter medium capturing particles contained in a to-be-filtrated gas and a supporting frame supporting the filter medium. The filter medium has a porous membrane of PTFE, a fibrous filter medium arranged so as to hold the PTFE membrane between the filter medium and a gas permeable supporting material. The fiber constituting the fibrous filter medium has an average fiber diameter of 0.02-15 μm (micron), and the gas permeable supporting material is composed of a fiber of an average fiber diameter of larger than 15 μm. The filter medium is supported with the supporting frame so that the fibrous filter medium lies in the downstream of the flow of the to-be-filtrated gas with respect to the PTFE membrane. According to the disclosure, the fibrous filter medium can be electrospun.

WO/2004/069959 discloses filtering of crude resin solution, which is a chemically amplified photoresist composition with an acid generator component. According to this disclosure, specific examples of filtration membrane materials include fluororesins such as PTFE; polyolefin resins, such as polypropylene and polyethylene; and polyamide resin, such as nylon 6 and nylon 66. The specification also discloses passing the crude resin solution through a two-stage filter using filtration membranes to effect removal of the polymer and oligomer by-products. In one specific example of the filtering process, the dilute crude resin solution is filtered through a nylon filter as the first filtration step, and the resulting filtrate is then filtered through a polypropylene filter as the second filtration step. A polyethylene filter was also disclosed as being used in this second filtration step.

United States Patent Application No. 2010/0038307 discloses filtration media including at least one layer of nanofibers having average diameters less than 1000 nanometers with optional porous substrate also referred to as a scrim layer(s). The porous substrates disclosed are spunbonded nonwovens, meltblown nonwovens, needle punched nonwovens, spunlaced nonwovens, wet laid nonwovens, resin-bonded nonwovens, woven fabrics, knit fabrics, apertured films, paper, and combinations thereof. The filtration media are disclosed as having mean flow pore sizes between about 0.5 microns, and about 5 microns, and are used for filtering particulate matter in liquid. The media are reported to have flow rates of at least 0.055 L/min/cm² at relatively high levels of solidity and non-diminishing flow rates as differential pressures increase between 2 psi (14 kPa) and 15 psi (100 kPa).

Photolithography is one of the most challenging steps in semiconductor device fabrication. It employs optical exposure to transfer a pattern from a photo mask onto a silicon wafer coated with a light-sensitive chemical called photoresist. Filtration of photoresist in the coater system to remove particles and gels is a critical step in the lithography process. Countless publications have shown that filtration can reduce defectivity associated with the lithography process. Filtration of gel particles from photoresist is particularly challenging because gel particles can change form and travel through traditional sieving filters.

Thus, there is a need for a filtration member with improved retention of gel particles in order to provide improved photoresist filtration.

### SUMMARY OF THE INVENTION

The present invention relates to a filtration member for photoresist filtration having improved gel retention. In one embodiment, the filtration member comprises a non-sieving membrane layer having a pore size rating of between about 10 nanometers and about 50 nanometers; a sieving membrane layer having a pore size rating of between about 2 nanometers and about 50 nanometers; and a nylon nanofiber layer having a pore size rating greater than the pore size rating of the nonsieving membrane and sieving membrane layers, a basis weight of between about 20 grams per square meter and about 35 grams per square meter and a mean isopropyl alcohol (IPA) bubble point of between about 3.5 pounds per square inch and about 5 pounds per square inch.

In some embodiments of the invention, the nylon nanofiber layer is interposed between the non-sieving membrane layer and the sieving membrane layer. In other embodiments, the non-sieving membrane layer is interposed between the sieving membrane layer and the nylon nanofiber layer. In yet other embodiments, the sieving membrane layer is interposed between the non-sieving membrane layer and the nylon nanofiber layer.

In some embodiments, the filtration member further comprises one or more layers of a porous support material.

In some embodiments, the filtration member comprises at least one nylon nanofiber layer. Specifically, the filtration member comprises three nylon nanofiber layers.

In some embodiments, the non-sieving membrane layer is a nylon membrane layer. Specifically, the nylon nanofiber layer and the nylon membrane layer are each independently nylon-6 or nylon-6,6. More specifically, the nylon nanofiber layer and the polyamide membrane layer are each nylon-6.

In some embodiments, the filtration member has an upstream end and a downstream end and the non-sieving membrane layer, the sieving membrane layer and the nylon nanofiber layer are arranged to form an upstream retentive layer, a center retentive layer and a downstream retentive layer, wherein the nylon nanofiber layer does not form the downstream retentive layer. Specifically, the nylon nanofiber layer forms the upstream retentive layer. More specifically, the non-sieving membrane layer forms the center retentive layer and the nylon nanofiber layer forms the upstream retentive layer. Alternatively, the sieving membrane layer forms the downstream retentive layer. Alternatively, the non-sieving membrane layer forms the upstream retentive layer and the nylon nanofiber layer forms the center retentive layer. Alternatively, the sieving membrane layer forms the upstream retentive layer.

In one embodiment, the filtration member comprises a polyamide membrane layer having a pore size rating of between about 10 nanometers and about 50 nanometers; an ultra high molecular weight polyethylene (UHMWPE) membrane layer having a pore size rating of between about 3 nanometers and about 50 nanometers; and a nylon nanofiber layer having a pore size rating greater than the pore size rating of the polyamide membrane and UHMWPE membrane layers, a basis weight of between about 20 grams per square meter and about 35 grams per square meter and a mean isopropyl alcohol (IPA) bubble point of between about 3.5 pounds per square inch and about 5 pounds per square inch.

In some embodiments of the invention, the nylon nanofiber layer is interposed between the polyamide membrane layer and the UHMWPE membrane layer. In other embodiments, the polyamide membrane layer is interposed between the UHMWPE membrane layer and the nylon nanofiber layer. In yet other embodiments, the UHMWPE membrane layer is interposed between the polyamide membrane layer and the nylon nanofiber layer.

In some embodiments, the filtration member has an upstream end and a downstream end and the polyamide membrane layer, the UHMWPE membrane layer and the nylon nanofiber layer are arranged to form an upstream retentive layer, a center retentive layer and a downstream retentive layer, wherein the nylon nanofiber layer does not form the downstream retentive layer. Specifically, the nylon nanofiber layer forms the upstream retentive layer. More specifically, the polyamide membrane layer forms the center retentive layer and the nylon nanofiber layer forms the upstream retentive layer. Alternatively, the UHMWPE membrane layer forms the downstream retentive layer. Alternatively, the polyamide membrane layer forms the upstream retentive layer and the nylon nanofiber layer forms the center retentive layer. Alternatively, the UHMWPE membrane layer forms the upstream retentive layer.

In some embodiments, the nylon membrane layer has a pore size rating of about 10 nanometers and the UPE membrane layer has a pore size rating of about 50 nanometers. Alternatively, the nylon membrane layer has a pore size rating of about 50 nanometers and the UPE membrane layer has a pore size rating of about 2 to about 5 nanometers.

Another embodiment of the invention is a filter comprising a housing and a filtration member of the invention.

Another embodiment of the invention is the use of a filtration member of the invention or a filter comprising a filtration member of the invention to remove gel from photoresist.

Another embodiment of the invention is a method of removing gel from photoresist, the method comprising passing a flow of photoresist through a filtration member of the invention or a filter comprising a filtration member of the invention, thereby removing gel from the photoresist.

There are several advantages associated with the filtration members of the invention. For example, the nanofiber layer increases the thickness of the filtration member and leads to improved residence time for the photoresist and also improved gel retention by the filtration member. By employing nylon in the nanofiber and microporous membrane layers, the non-sieving retention of the filtration member is improved, which reduces defects, particularly gel-based defects, in the lithographic process and increases the lifetime of a filter containing the filtration member. Unexpectedly, the nylon nanofiber layer also reduces the pressure drop caused by using multiple filter layers, which can improve particle and gel retention, reduce defectivity in photolithographic processes, reduce yield loss, and provide a bigger window of operation for the spin-coating process.

### BRIEF DESCRIPTION OF THE DRAWINGS

FIG. 1 illustrates some non-limiting versions of filtration members of the invention that include two microporous or nanoporous membrane layers and a nanofiber layer.

FIG. 2 is a graph of the percent retention of exemplary filtration members of the invention as a function of percent monolayer coverage.

FIG. 3 is a graph of the percent gold particle absorption of various nylon membranes as a function of volume (milliliters) of a 200 ppb solution of 5-nm gold particles in deionized water.

FIG. 4 is a graph of the weight of phthalic acid (μg) measured downstream of various filter members as a function of filtered volume of a solution of phthalic acid in water.

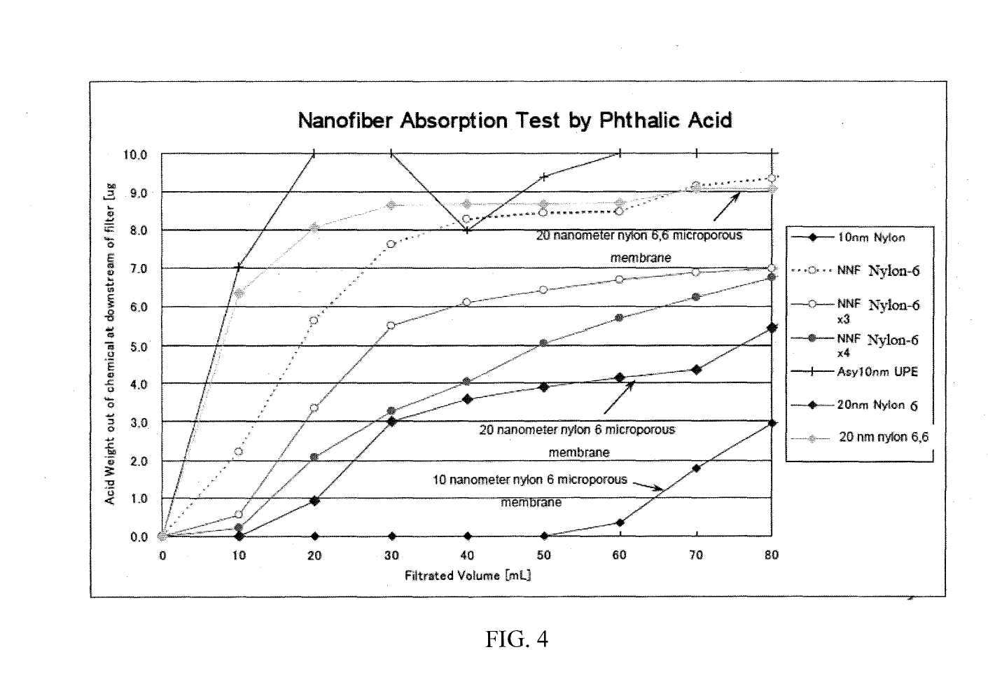

### DETAILED DESCRIPTION OF THE INVENTION

While various compositions and methods are described, it is to be understood that this invention is not limited to the particular molecules, compositions, designs, methodologies or protocols described, as these may vary. It is also to be understood that the terminology used in the description is for the purpose of describing the particular versions or embodiments only, and is not intended to limit the scope of the present invention which will be limited only by the appended claims.

As used herein and in the appended claims, the singular forms “a”, “an”, and “the” include plural reference unless the context clearly dictates otherwise. Thus, for example, reference to a “nanofiber” is a reference to one or more nanofibers and equivalents thereof known to those skilled in the art, and so forth. Unless defined otherwise, all technical and scientific terms used herein have the same meanings as commonly understood by one of ordinary skill in the art. Methods and materials similar or equivalent to those described herein can be used in the practice or testing of embodiments of the present invention. All publications mentioned herein are incorporated by reference in their entirety. Nothing herein is to be construed as an admission that the invention is not entitled to antedate such disclosure by virtue of prior invention. “Optional” or “optionally” means that the subsequently described event or circumstance may or may not occur, and that the description includes instances where the event occurs and instances where it does not. All numeric values herein can be modified by the term “about,” whether or not explicitly indicated. The term “about” generally refers to a range of numbers that one of skill in the art would consider equivalent to the recited value (i.e., having the same function or result). In some embodiments the term “about” refers to ±10% of the stated value, in other embodiments the term “about” refers to ±2% of the stated value. While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed or closed member groups.

Although the invention has been shown and described with respect to one or more implementations, equivalent alterations and modifications will occur to others skilled in the art based upon a reading and understanding of this specification and the annexed drawings. The invention includes all such modifications and alterations and is limited only by the scope of the following claims. In addition, while a particular feature or aspect of the invention may have been disclosed with respect to only one of several implementations, such feature or aspect may be combined with one or more other features or aspects of the other implementations as may be desired and advantageous for any given or particular application. Furthermore, to the extent that the terms “includes,” “having,” “has,” “with,” or variants thereof, are used in either the detailed description or the claims, such terms are intended to be inclusive in a manner similar to the term “comprising.” Also, the term “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from those illustrated herein.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

A description of example embodiments of the invention follows.

The teachings of all patents, published applications and references cited herein are incorporated by reference in their entirety.

While this invention has been particularly shown and described with reference to example embodiments thereof, it will be understood by those skilled in the art that various changes in form and details may be made therein without departing from the scope of the invention encompassed by the appended claims.

Performance of a filter depends on various attributes, such as sieving retention performance, non-sieving retention performance, membrane thickness, fluid residence time in the filter membrane, fluid path through the membrane (laminar or turbulent), and membrane flow performance or flow time. Another important filter attribute is the thickness of the boundary layer of the liquid at the membrane (the liquid interface), which is a function of the shear rate; this interface affects flow distribution (channeling) of the liquid stream.

One version of the invention is a filter member (can also be referred to as a filtration member or composite membrane) comprising a sieving microporous or nanoporous membrane having a pore size rating of about 2 nanometers to about 50 nanometers, as determined by IPA or HFE-7200 bubble point, a non-sieving microporous or nanoporous membrane having a pore size rating of about 10 nanometers to about 50 nanometers, as determined by IPA or HFE-7200 bubble point, and a nanofiber layer that has a pore size rating greater than the pore size rating of the sieving microporous or nanoporous membrane and the non-sieving microporous or nanoporous membrane. In some embodiments, the nanofiber layer has a pore size rating of about 1.75 microns to about 2.5 microns, as determined by IPA bubble point. In some embodiments, the nanofiber layer has a basis weight of between about 20 grams per square meter and about 35 grams per square meter. In some embodiments, the nanofiber layer has a mean isopropyl alcohol (IPA) bubble point of between about 3.5 pounds per square inch and about 5 pounds per square inch.

As used herein, “sieving membrane” refers to a membrane that captures particles or is optimized to capture particles primarily via a sieving retention mechanism. Exemplary sieving membranes include, but are not limited to, Teflon membranes and UHMWPE membranes.

As used herein, “sieving retention mechanism” refers to retention that is the result of the particles being larger than the pores in a filter or microporous membrane. Sieving retention can be enhanced by formation of a filter cake (an agglomeration of particles at the surface of the filter or membrane), which effectively acts as a secondary filter.

As used herein, “non-sieving membrane” refers to a membrane that captures particles or is optimized to capture particles primarily via non-sieving retention mechanisms. In the filtration of gels, which are often negatively charged, a nylon membrane acts as a non-sieving membrane. Exemplary non-sieving membranes include, but are not limited to, nylon membranes, such as nylon-6 or nylon-6,6 membranes.

As used herein, “non-sieving retention mechanism” refers to retention that occurs by mechanisms, such as interception, diffusion and adsorption, that are not related to the pressure drop or bubble point of the filter or microporous membrane.

It is to be understood that a membrane can operate via either or both sieving and non-sieving retention mechanisms, depending on the filtration conditions. These terms are used herein with reference to typical conditions present during the filtration of photoresist.

The ratio of the pore sizes, determined by bubble point, for the sieving microporous membrane to the non-sieving microporous membrane can be 10 to 1, about 10 to about 1, 5 to 1, about 5 to about 1, 3 to 1 or about 3 to about 1. For example, in one embodiment of the invention, the nanofiber layer is interposed between a microporous UHMWPE membrane with a 50 (±20 percent) nanometer pore size rating as determined by bubble point and a nylon microporous membrane with a 10 (±20 percent) nanometer pore size rating as determined by bubble point. This combination is advantageous to optimize non-sieving retention (gel/agglomerates) while maintaining good flow.

The ratio of the pore sizes, determined by bubble point, for the non-sieving microporous membrane to the sieving microporous membrane can be 5-25 to 1, 10-25 to 1, 5-10 to 1, about 5-25 to about 1, about 10-25 to about 1 or about 5-10 to about 1. For example, a combination of membranes in a version of the invention that can be used to maximize sieving retention includes a nylon nanofiber layer interposed between a nylon microporous membrane that has a 50 (±20 percent) nanometer pore size rating determined by bubble point and a microporous UHMWPE membrane that has a 5(±20 percent) nanometer pore size rating determined by bubble point or a 2 (±20 percent) nanometer pore size rating determined by bubble point.

One embodiment of the invention is a filtration member comprising three layers. One layer is a non-sieiving (e.g., nylon) membrane layer having a pore size rating of between about 10 nanometers and about 50 nanometers. A second layer is a sieving (e.g., UHMWPE) membrane layer having a pore size rating of between about 2 nanometers and about 50 nanometers. A third layer is a nylon nanofiber layer having a pore size rating greater than the pore size rating of the polyamide membrane and UHMWPE membrane layers.

The three layers may be referred to with reference to an intended direction of fluid flow. In these embodiments, the three layers can be referred to as an upstream retentive layer, a center retentive layer and a downstream retentive layer.

For purposes of the description and claims, the term “microporous membrane” will be used to include porous membranes that may also be described by terms such as ultraporous membranes, nanoporous membranes, and microporous membranes. These microporous membranes retain feed stream components (retentate) such as, but not limited to gels, particles, colloids, cells, poly-oligomers, while components substantially smaller than the pores pass through the pores into a permeate steam. Retention of components in the feed stream by the microporous membrane can be dependent upon operating conditions, for example, face velocity and use of surfactants, pH and combinations of these, and can be dependent upon the size and structure (hard particle or gel) of the particle relative to the size, structure and distribution of the microporous membrane pores. In a preferred embodiment, the microporous membrane is a nanoporous membrane.

“Percent retention” as used herein, refers to the percentage of particles removed from a fluid stream by a filtration member placed in the pathway of the fluid stream. Nanometer-sized fluorescent polystyrene latex (PSL) beads can be used to measure percent retention of the filter members and microporous membranes of the invention utilizing the methods and materials disclosed in “Sub-30 nm Particle Retention Test by Fluorescence Spectroscopy,” Yaowu, Xiao, et al., Semicon China; Mar. 19-20, 2009, Shanghai, China, the contents of which are incorporated herein by reference in their entirety. In some versions of the invention, the fluorescent nanoparticles are G25 particles. G25 particles are distributed by Duke Scientific who lists the nominal diameter of the particles at 25 nanometers. However, particles in the range of 20 nanometers to 30 nanometers, in some cases 21 nanometers to 24 nanometers, can be used. The percent fluorescent particle monolayer coverage used to evaluate the filter members can be between 1% and 30%, although other percent monolayer coverage can also be is used.

Retention efficiency, or log reduction value (LRV) is another measure of the efficiency of a filter member or microporous membrane. LRV of a filter member or microporous membrane can be calculated, for example, from experiments employing fluorescent PSL beads. Log reduction value (LRV) is defined as the following:

LRV=Log₁₀(inlet concentration/outlet concentration).

Sieving percent retention, or percent retention under sieving or essentially sieving conditions, can be assessed using various surfactants. Sieving retention results because particles are larger than the pores in a filter or microporous membrane. Sieving retention can be enhanced by formation of a filter cake (an agglomeration of particles at the surface of the filter or membrane), which effectively acts as a secondary filter. The use of a surfactant minimizes non-sieving effects of the microporous membrane, nanofiber layers, and optional support materials and provides sieving or essentially sieving conditions for the particle retention tests. It is expected that under these sieving conditions (or essentially sieving conditions) that the particle retention of the filter member or components like the microporous membrane, can be correlated with the particle retention properties of the filter member in organic liquids, compositions like photoresist and antireflective coatings containing organic liquids, and other similar liquids where filtration is dominated by the sieving filtration properties of the filter member or microporous membrane. In some embodiments of the invention, a filter or microporous membrane has a percent retention under sieving conditions of from about 90% to about 99.99%, from about 95% to about 99.99%, from about 98% to about 99.99%, or from about 99% to about 99.99%. In some embodiments, the filter or microporous has a percent retention under sieving conditions of at least about 90%, at least about 95%, at least about 98%, or at least about 99%.

In some versions of the invention, the surfactant is sodium dodecyl sulfate (SDS) or Triton X-100 [(C₁₄H₂₂O(C₂H₄O)ₙ], a nonionic surfactant which has a hydrophilic polyethylene oxide group (on average 9.5 ethylene oxide units) and a hydrocarbon lipophilic or hydrophobic group. The hydrocarbon group is a 4-(1,1,3,3-tetramethylbutyl)-phenyl group. The amount of surfactant used can be chosen to be above the critical micelle concentration (CMC). A surfactant concentration above the CMC can be measured using a surface tensiometer to monitor the surface tension of the fluid. In some versions of the invention, the surfactant ranges from 0.1% (w/w) to 0.3% (w/w), which provides sieving or essentially sieving conditions.

The microporous or nanoporous non-sieving membrane layer can have a pore size rating based on isopropyl alcohol (IPA) (or equivalent, like HFE 7200) porisometry bubble point of between 5 nanometers and 100 nanometers, between 5 nanometers and 50 nanometers or between 10 nanometers and 50 nanometers. The microporous or nanoporous sieving membrane layer can have a pore size rating based on IPA (or equivalent, like HFE 7200) porisometry bubble point of between 2 nanometers and 200 nanometers, 2 nanometers and 100 nanometers, 2 nanometers and 50 nanometers, 10 nanometers and 50 nanometers or 3 nanometers and 50 nanometers.

Nonsieving retention includes retention mechanisms, such as interception, diffusion and adsorption, that remove particles from a fluid stream without being related to the pressure drop or bubble point of the filter or microporous membrane. Particle adsorption to membrane surfaces can be mediated by, for example, intermolecular Van der Waals and electrostatic forces. Interception occurs when a particle travelling through a tortuous membrane cannot change direction fast enough to avoid contact with the membrane. Particle transport due to diffusion results from random or Brownian motion of predominantly small particles, which creates a certain probability that the particles will collide with the filter media. Non-sieving retention mechanisms can be active when there is an absence of repulsive forces between the particle and the filter or membrane. Therefore, in some embodiments of the invention, non-sieving percent retention can be assessed under neutral conditions (e.g., at or near the isoelectric point of the membrane or filter).

Gels can be negatively charged. Therefore, a filter member having a microporous membrane having a positive charge density (e.g., a polyamide or nylon membrane) can be useful to remove gels from a liquid stream via a non-sieving retention mechanism. In other embodiments of the invention, non-sieving percent retention can be assessed under acidic conditions (e.g., at a pH below the isoelectric point of the membrane or filter). Non-sieving percent retention can be assessed using, for example, gold nanoparticles.

Another version of the invention is a filtration member that includes a layer of microporous polyamide membrane, a layer of microporous ultra high molecular weight polyethylene (UHMWPE) membrane, and a layer of polymeric nylon nanofiber. The microporous or nanoporous polyamide membrane layer can have a pore size rating based on isopropyl alcohol (IPA) (or equivalent, like HFE 7200) porisometry bubble point of between 5 nanometers and 100 nanometers, between 5 nanometers and 50 nanometers or between 10 nanometers and 50 nanometers. The microporous or nanoporous UHMWPE membrane layer can have a pore size rating based on IPA (or equivalent, like HFE 7200) porisometry bubble point of between 2 nanometers and 200 nanometers, 2 nanometers and 100 nanometers, 2 nanometers and 50 nanometers, 10 nanometers and 50 nanometers or 3 nanometers and 50 nanometers. The nanofiber layer can have a pore size rating greater than either the pore size rating of the polyamide membrane layer or the pore size rating of the UHMWPE membrane layer, a basis weight of between 20 grams per square meter and 35 grams per square meter, and a mean IPA bubble point of between 3.5 pounds per square inch and 5 pounds per square inch.

The non-sieving membrane layer or the sieving membrane layer can be the upstream or downstream layer of the filtration member in the fluid path depending on filter configuration within a support frame or housing. In other versions of the invention, the layer of polymeric nylon nanofiber can be the upstream layer of the fluid path or the layer of polymeric nylon nanofiber can be interposed between the sieving membrane layer and the non-sieving membrane layer, depending on filtration member configuration.

Nanofibers, microporous and nanoporous membranes, and methods of characterizing them, are disclosed in International Patent Application Publication No. WO 2010/120668, the contents of which are incorporated herein by reference in their entirety.

The nanofibers of the invention are formed of polymers. In some versions of the invention, the polymer used to form the nanofiber material is the same as the polymer used to form one of the microporous membrane retentive layers. Polyamides, polyolefins, polyimides, polyvinyl alcohols, and polyesters can be used in versions of the invention for the nanofiber layer. Polyamide condensation polymers (nylon materials) that can be used include, but are not limited to, nylon-6, nylon-6,6, nylon 6,6-6,10, and the like. When the polymer nanofiber layer of the invention is formed by meltblowing, any thermoplastic polymer capable of being meltblown into nanofibers can be used, including polyolefins, such as polyethylene, polypropylene and polybutylene, polyesters such as poly(ethylene terephthalate) and polyamides, such as the nylon polymers listed above. In a preferred embodiment, the polymeric nanofibers are polymeric nylon nanofibers. Specifically, the polymeric nylon nanofibers are nylon-6 or nylon-6,6 nanofibers. More specifically, the polymeric nylon nanofibers are nylon-6. Alternatively, the polymeric nylon nanofibers include or consist of any nylon nanofiber having an absorption of gold nanoparticles within about 25%, about 10% or about 5% of the absorption of gold nanoparticles of nylon-6.

The nanofiber layer can comprise or consist of nanofibers that can be produced by electrospinning, such as classical electrospinning or electroblowing, and in certain circumstances, by meltblowing or other such suitable processes. Classical electrospinning is a is technique illustrated in U.S. Pat. No. 4,127,706, the teachings of which are incorporated herein by reference in their entirety, wherein a high voltage is applied to a polymer in solution to create nanofibers and nonwoven mats. Nanofibers in versions of the invention can be electrospun, or can include combinations of, for example, melt blown nanofibers and electrospun nanofibers.

In versions of the invention, the pore size rating of the nanofiber layer, determined by IPA or 3M® HFE-7200 bubble point, or equivalent, is greater than the size rating of the microporous membrane layers, also determined by bubble point, in the composite membrane. Accordingly, the nanofiber layer will have a lower bubble point in IPA than either of the microporous membranes in the filter member. In some versions of the invention, the mean IPA bubble point of the nanofiber layer (determined by porisometry) is between about 3.5 pounds per square inch and about 5 pounds per square inch.

The thickness of the nanofiber layer in some versions of the filtration member can range from about 110 microns to about 170 microns, about 120 microns to about 150 microns, about 110 microns to about 130 microns or about 135 microns to about 170 microns. Fiber diameter (determined by SEM analysis) can vary from about 350 nanometers to 1200 nanometers, with a mean diameter in the range of about 500 nanometers to 800 nanometers. Fiber diameters of nanofiber samples can be measured on a representative sample (ignore very large or very small diameter fibers, e.g., those that are larger or smaller than 95% of the other fibers) using, for example, FEI Scanning Electron Microscope (3000 magnification to 5000 magnification) with Soft Image System software and calculating fiber diameters and mean values based on 10 to 20 data points. In some versions of the invention, the mean fiber diameter is about 750 nanometers. In other versions of the invention, the mean fiber diameter is about 700 nanometers to about 800 nanometers. In some versions of the invention, the basis weight for the nanofiber layer can be about 20 grams per square meter to about 35 grams per square meter, the density of the nanofiber layer can be 0.2 (±10%) grams per cubic centimeter, and the air permeability between 6 (seconds/200 milliliters) and 10.5 (seconds/200 milliliters).

In the invention, the nanofiber layer in the filtration member retains approximately 25 nanometer-sized fluorescent nanoparticles under sieving conditions (0.1% Triton X-100 surfactant added to PSL bead and deionized water solution). In some versions of the invention, the retention of the nanofiber layer in the filtration member under sieving conditions (0.1% Triton X-100 surfactant added to PSL bead and deionized water solution) for 25 nanometer (nominal) fluorescent PSL beads is 85 (±5) percent to 98 (±5) percent, or more, for a monolayer of the fluorescent PSL beads when the nanofiber layer is challenged with about 8 parts per billion solution (weight/weight) containing the fluorescent PSL beads (8 ppb concentration of PSL beads can be used to deposit 1% monolayer of the 25 nm fluorescent PSL beads on sample membrane surface 90 millimeter membrane disk when 100 milliliters of the 8 ppb solution of fluorescent bead passes through the membrane disk). In some versions of the invention, the retention of the nanofiber layer in the filtration member for 25 nanometer (nominal) fluorescent PSL beads is 90 (±5) percent or more for five or fewer monolayers of the fluorescent PSL beads on the filter member when the membrane is challenged repeatedly with the 8 ppb solution of the 25 nm fluorescent PSL beads under sieving conditions. The Gurley Number for the nanofiber layer in some versions of the invention can range from about 5.75 seconds per 100 milliliters to about 10.75 seconds per 100 milliliters for a test sample with a 28.6 millimeter diameter.

In some versions of the invention, the nanofiber layer further includes a support material in contact with the nanofiber layer. Specifically, the support material is a non-woven support material. Exemplary non-woven support materials for the nanofiber layer include, but are not limited to, non-woven nylon, non-woven polyethersulfone (PES) or non-woven UHMWPE.

In some version of the invention, the filtration member comprises at least one nylon nanofiber layer. Specifically, the filtration member comprises at least two, at least three, or at least four nylon nanofiber layers. Alternatively, the filtration member comprises one, two, three, four or five nylon nanofiber layers.

In some versions of the invention, the microporous sieving membrane is an ultra high molecular weight polyethylene (UHMWPE or UPE) membrane. UPE is a version of thermoplastic polyethylene that has extremely long chains, with molecular weight numbering in the millions, for example 1 million or more, usually between 2 and 6 million. In some versions of the invention, the sieving microporous membrane comprises or consists of UPE. Alternatively, the sieving microporous membrane is a fluoropolymer or perfluoropolymer, such as PTFE. Specifically, the sieving microporous membrane is PTFE.

In some versions of the invention, the non-sieving microporous membrane, or microporous membrane having non-sieving properties, comprises or consists of nylon (also referred to herein as polyamide). More specifically, the nylon microporous membrane is a nylon-6 or nylon-6,6 microporous membrane. Yet more specifically, the nylon microporous membrane is a nylon-6 microporous membrane. Alternatively, the non-sieving nylon microporous membrane includes or consists of any nylon having an absorption of gold nanoparticles within about 25%, about 10% or about 5% of the absorption of gold nanoparticles of nylon-6.

The sieving and non-sieving microporous membranes can each independently have a mean IPA bubble point, an equivalent bubble point using another solvent and compensating for surface tension, such as HFE-7200 from 3M®, greater than about 20 psig, in some cases, greater than 30 psig, and in still other cases, greater than about 50 psig. In some versions, the sieving and non-sieving microporous membranes each independently have a mean IPA bubble point, or an equivalent bubble point using another solvent and compensating for surface tension, such as HFE-7200 from 3M®, of from 20 psig to 150 psig.

In versions of the invention, the sieving and non-sieving microporous membranes each independently have a mean bubble point in liquid HFE-7200 from 3M®, of from 75 psi to 90 psi, in some cases an average bubble point in HFE-7200 of about 85 psi (586,054 Pa). In some versions of the invention, the sieving and non-sieving microporous membranes each have a mean bubble point in HFE-7200 from 3M®, of from 95 psi to 110 psi, in some cases, an average bubble point of about 100 psi (689,476 Pa). In some versions of the invention, the sieving and non-sieving microporous membranes each have a mean bubble point in HFE-7200 from 3M®, of from 115 psi to 125 psi, in some cases, an average bubble point of about 120 psi (827,371 Pa). In still other versions of the invention, the sieving and non-sieving microporous membranes each have a mean bubble point in the liquid HFE-7200 from 3M®, of from 140 psi to 160 psi. The sieving and non-sieving microporous membranes can each independently be symmetric or asymmetric microporous membranes.

In some versions of the invention, the sieving microporous membrane can be an asymmetric UPE membrane made by Entegris, Inc., referred to as a 10 nanometer asymmetric rated membrane that has a mean bubble point in the liquid HFE-7200 from 3M®, of from 75 psi to 90 psi, in some cases an average bubble point of about 85 psi (586,054 Pa), In some versions of the invention, the sieving microporous membrane can be an asymmetric UPE membrane made by Entegris, Inc., referred to as a 5 nanometer asymmetric rated membrane that has a mean bubble point in the liquid HFE-7200 from 3M®, of from 95 psi to 110 psi, in some cases, an average bubble point of about 100 psi (689,476 Pa). In some versions of the invention, the sieving microporous membrane can be an asymmetric UPE membrane made by Entegris, Inc., referred to as a 3 nanometer rated asymmetric membrane that has a mean bubble point in the liquid HFE-7200 from 3M®, of from 115 psi to 125 psi, in some cases, an average bubble point of about 120 psi (827,371 Pa).

In some versions of the invention, the sieving and non-sieving microporous membranes are characterized by an IPA flow time in a range of 350 seconds to 6500 seconds, in some cases from 500 seconds to 6500 seconds for 500 milliliters of IPA at a pressure of 0.10 MPa and temperature of 21° C. The IPA flow time for an asymmetric 0.005 micron (5 nm) UPE membrane with a mean bubble point in the liquid HFE-7200 from 3M® of from 75 psi to 90 psi can range from 5000 seconds to 7000 seconds for 500 mL IPA at 0.1 MPa pressure at 21° C.

IPA flow time is the time to flow 500 milliliters of isopropyl alcohol, at a temperature of 21° C. and pressure of 97,900 Pa (about 0.1 MPa, or about 14.2 psid), through a 47 millimeter disk of the microporous membrane alone or a filter member (for example, microporous membrane, nanofiber layer, and optional support with an area of 12.5 cm².

The bubble point refers to a mean IPA bubble point using an air flow porisometer. In some cases microporous membrane bubble points refer to a mean bubble point measured in HFE-7200 (available from 3M®, St. Paul, Minn.). HFE-7200 bubble points can be converted into IPA bubble point values by multiplying the HFE 7200 measured bubble point by 1.5, or about 1.5. 3M® HFE-7200 is ethoxy-nonafluorobutane and has a reported surface tension of 13.6 mN/m at 25° C.

The sieving and non-sieving microporous membranes may have symmetric, asymmetric or combinations of these (for example, in the filtration member, one microporous membrane can be symmetric and the other microporous membrane asymmetric) pore structure in the filter member. Symmetric microporous membranes have a porous structure with a pore size distribution characterized by pores with an average size that is substantially the same through the membrane. In asymmetric microporous membranes, the size of the pores varies through the membrane, in general, increasing in size from one surface, the tight side, to the other surface of the membrane, the open side. In some versions of the invention, microporous membrane may be a skinned membrane where the skinned side of the membrane is liquid permeable. Other types of asymmetry are known. For example, those in which the pore size goes through a minimum pore size at a position within the thickness of the membrane (hour glass shape). Asymmetric microporous membranes tend to have higher fluxes compared to symmetric microporous membranes of the same rated pore size and thickness. Also, asymmetric microporous membranes can be used with the larger pore side facing the fluid stream being filtered, creating a pre-filtration effect. Microporous membranes in versions of the invention can have pore structure chosen from the group consisting of symmetric, asymmetric, and hour glass. In some versions of the invention, the pore structure of the microporous membrane is asymmetric.

The filtration member can further comprise one or more layers of a support material. A support material can be placed on one or more sides of the retentive layers in the filtration member. Support materials include, but are not limited to, various netting materials, non-woven porous materials, spun-bond materials, and the like. The support is permeable to liquids and, in some versions of the invention, is chosen so that the flow time of the filter member is essentially the same or is less than the flow time of the microporous membranes alone. The support can provide strength for the handling of the nanofiber and/or membranes in the pleating/cartridge assembly process. Since the support can be a depth media, it may also act as a filter media. In some versions of the invention, the support is a non-woven material. The support or non-woven support is chemically compatible with the final liquid application. Non-limiting examples of non-woven supports include those made from polyamides (PA) and can include various nylons such as but not limited to Nylon 6, Nylon 6,6, and aramides, poly(ethylene terephthalate) (PET), PES (polyether sulfone) and the like. PA6 refers to Polyamide 6 also referred to as Nylon 6 or Nylon 6,6. In some versions of the invention, the nonwoven support comprises Nylon 6 resin that is heat bonded to reduce the chance of introduction other unwanted material (contamination) into the web via other processes. In one version of the invention, the support is nylon, N05040, available from Asahi Kasei which does not affect, or does not substantially affect, the flow time of the filter member. The basis weight of the nonwoven is related to its thickness and can be chosen to minimize pressure loss and may also be selected to provide the correct number of pleats for assembly into a filter pack. As the nonwoven gets thicker, it reduces the number of pleats that can fit into a fixed diameter center tube configuration of a filter cartridge. In some versions of the invention the non-woven support has a basis weight of about 40 grams per meter squared to about 30 grams per meter squared. In other versions of the invention the non-woven support has a basis weight of about (40±5) grams per meter squared.

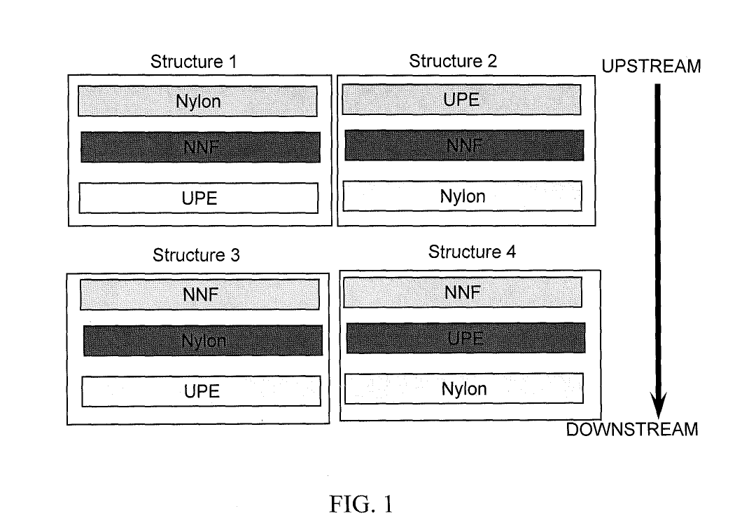

FIG. 1 illustrates some non-limiting versions of filtration members of the invention that include three distinct membrane layers, two microporous or nanoporous membrane layers and a nanofiber layer. For example, Structure 1 shows a composite membrane with a microporous nylon membrane as the upstream retentive layer, a nylon nanofiber as the center retentive layer, and a microporous UHMWPE membrane as the downstream retentive layer. Structure 2 shows a composite membrane with a microporous nylon membrane as the downstream retentive layer, a nylon nanofiber as the center retentive layer, and a microporous UHMWPE membrane as the upstream retentive layer. Structure 3 shows a composite membrane with a microporous nylon membrane as the center retentive layer, a nylon nanofiber as the upstream retentive layer, and a microporous UHMWPE membrane as the downstream retentive layer. Structure 4 shows a composite membrane with a microporous nylon membrane as the downstream retentive layer, a nylon nanofiber layer as the upstream retentive layer, and a microporous UHMWPE membrane as the center retentive layer. Advantageously, the order of layers and type of material can be modified depending upon the filtration application and target defect (e.g., particle, gel, combination thereof) to be removed.

The materials used for the housing (core, cage and end caps) as well as the potting/bonding material used to seal the membrane to the endcaps can include polyethylene for potting and high density polyethylene materials for the shell, core, cage, and other supports. Other potting materials that can be used are known to those skilled in the art.

Another embodiment of the invention is a filter comprising a housing and a filtration member of the invention.

Another embodiment of the invention is the use of a filtration member of the invention or a filter comprising a filtration member of the invention to remove gel from photoresist. Advantageously, the nanofiber layer of the filtration members of the present invention increases the thickness of the filtration member, thereby providing improved residence time for the photoresist and also improved gel retention. By employing nylon in the nanofiber layer, the non-sieving retention of the filtration member is improved, which reduces defects, particularly gel-based defects, in the lithographic process and increases the lifetime of a filter containing the filtration member. Unexpectedly, the nylon nanofiber layer also reduces the pressure drop caused by using multiple filter layers, which can improve particle and gel retention, reduce defectivity in photolithographic processes, reduce yield loss, and provide a bigger window of operation for the spin-coating process.

Another embodiment of the invention is a method of removing gel from photoresist, the method comprising passing a flow of photoresist through a filtration member of the invention or a filter comprising a filtration member of the invention, thereby removing gel from the photoresist. In some embodiments, the flow rate of the photoresist is from about 0.2 cc/min to about 3 cc/min In some embodiments, the pressure drop of the filtration member is less than or equal to about 1 psi.

### EXEMPLIFICATION

### Example 1

### Leak Test, Bubble Point and Flow Rate

An exemplary filter member of the invention was characterized by leak test, bubble point and flow rate. The exemplary filter member included a Delnet III non-woven layer; a nanofiber layer with a basis weight of about 30 grams per square meter, a mean IPA bubble point of 4.5 (±10%) pounds per square inch, a thickness of about 165 (±2%) microns, and a mean fiber diameter of about 750 nanometers (for example, determined by SEM analysis); a 0.05 micron pore size rated microporous UPE membrane from Entegris; a Delnet III non-woven layer; a microporous 0.01 micron pore size rated nylon membrane from Entegris; and a Delnet non-woven layer. The weight of the filter member was measured using a scale. The leak test was performed by submerging the filter member into a water tank, pressurizing the filter member to 0.35 MPa for 60 seconds, and inspecting the filter member for leaks. The bubble point was measured by pre-wetting the filter member with 60% IPA in water for about 20 seconds, then watching for a visible bubble at the downstream end of the filter member as the pressure was increased. The flow rate was measured by pre-wetting the filter member in 60% IPA in water for about 20 seconds, pressurizing the filter member to 0.6 kg/cm², and measuring the liquid flow rate after about 1 minute. The bubble point for this filtration member was greater than 42 pounds per square inch and the filtration member had a water flow rate of between 0.22 and 0.46 liters per minute at a pressure of 0.6 kg/cm² (the mean water flow rate was 0.4 liters/minute at a pressure of 0.6 kg/cm²).

The flow rate for this filtration member (or filter member) is similar to a 10 nanometer pore size rated (by IPA or HFE 7200 bubble point) asymmetric UPE microporous membrane.

TABLE 1
Results of leak test, bubble point (B.P.) and flow tests.

| | | | | Prewet |
|---|---|---|---|---|
| Sample | Weight | Leak Test | Manual B.P. | flow rate [L/min] |
| No. | [g] | 0.34 Mpa × 60 sec | Mean [psi] | 0.6 kg/cm² |
| 1 | 120.22 | OK | >42.0 | 0.43 |
| 2 | 120.02 | OK | >42.0 | 0.38 |
| 3 | 120.06 | OK | >42.0 | 0.43 |
| 4 | 119.88 | OK | >42.0 | 0.46 |
| 5 | 119.71 | OK | >42.0 | 0.40 |
| 6 | 119.58 | OK | >42.0 | 0.43 |
| 7 | 119.40 | OK | >42.0 | 0.39 |
| 8 | 120.30 | OK | >42.0 | 0.42 |
| 9 | 119.41 | OK | >42.0 | 0.42 |
| 11 | 120.05 | OK | >42.0 | 0.34 |
| 12 | 119.95 | OK | >42.0 | 0.22 |
| 13 | 120.17 | OK | >42.0 | 0.46 |
| 14 | 119.69 | OK | >42.0 | 0.41 |
| 15 | 120.01 | OK | >42.0 | 0.45 |
| average | | | | 0.40 |

The samples were cleaned and oven dried at 70° C. Then, particle shedding from the filter member described above was assessed using a RION KS-40 particle counter at a flow rate of 10 mL/min. Data collection was begun after a 5 minute flush.

Table 2 shows the results of the particle shed testing performed as described above. The composite filters of the example can be made clean and can be flushed to have 5 or fewer particles greater than or equal to 0.3 microns after 10 minutes of flushing at 10 milliliters per minute flow of DI water.

TABLE 2
Particle shed test results for one of the sample cartridges of this example.

| | 1 min | 2 min | 3 min | 4 min | 5 min | 6 min | 7 min | 8 min | 9 min | 10 min |
|---|---|---|---|---|---|---|---|---|---|---|
| ≧0.1 um | 66 | 14 | 11 | 8 | 13 | 2 | 5 | 2 | 2 | 2 |
| ≧0.15 um | 15 | 3 | 0 | 2 | 6 | 1 | 2 | 0 | 0 | 1 |
| ≧0.2 um | 4 | 0 | 0 | 1 | 2 | 0 | 1 | 0 | 0 | 1 |
| ≧0.3 um | 0 | 0 | 0 | 0 | 1 | 0 | 0 | 0 | 0 | 1 |
| ≧0.5 um | 0 | 0 | 0 | 0 | 0 | 0 | 0 | 0 | 0 | 0 |

### Example 2

### Retention of Fluorescent PSL Beads

In this experiment, seven 47-millimeter (mm) disk membrane coupons were challenged with 25-nm fluorescent particles (Duke Scientific G25) suspended in a surfactant solution (0.06% Triton X-100 in DI water). The retention test was conducted with a consistent flow rate of about 0.75 liters/minute. An analytical balance was used to measure loading values from 1% to 6% monolayer coverage on the membrane.

Fluorescence spectroscopy was carried out on Hitachi F-7000 fluorescence spectrometer. The excitation/emission wavelengths of the G25 particles were selected as 468/506 nm and a cuton optical filter was installed to minimize interfering excited light appearing in the emission spectra. Fluorescence spectra of the filtrate solutions were collected during testing.

Sample #1 corresponds to a filter member that is an Impact 2 Duo (5 nm UPE and nylon nanofiber, available from Entegris, Inc.). Sample #2 corresponds to a filter member that is an Impact 2 Duo (3 nm UPE, nylon nanofiber and a Kalrez o-ring, available from Entegris, Inc.). Sample #3 corresponds to a filter member that is an Impact 2 Duo (V20M, 5 nm UPE and nylon nanofiber, available from Entegris, Inc.). Sample #4 corresponds to a filter member including a 3 nm asymmetric UHMWPE membrane having a surface area of 1250 cm² (available from Entegris, Inc.). Sample #5 corresponds to a filter member including an nylon nanofiber membrane, a 50-nm UHMWPE membrane and a 10 nm nylon membrane having a surface area of 600 cm². Sample #6 corresponds to a filter member including a nylon nanofiber membrane, a 50-nm UHMWPE membrane and a 10 nm nylon membrane having a surface area of 600 cm². Samples #5 and #6 are exemplary filter members of the invention.

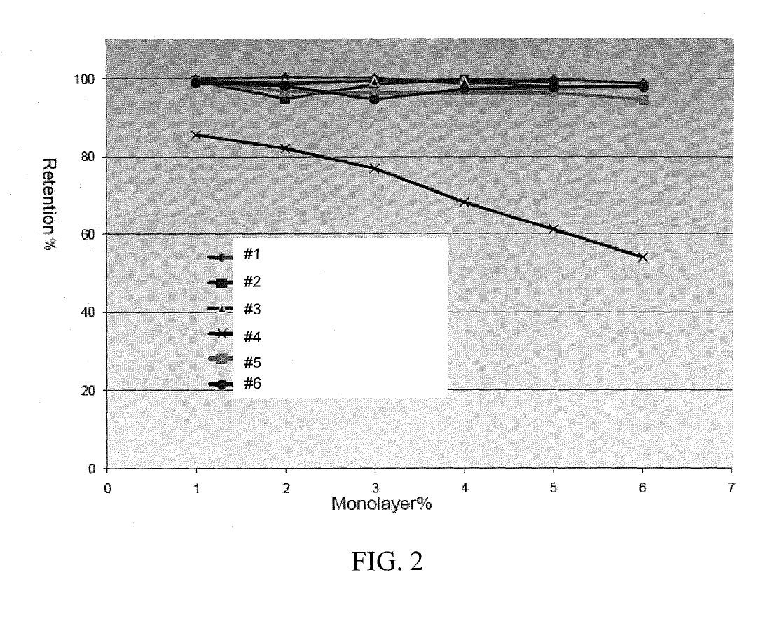

FIG. 2 shows that Samples #5 and #6 have comparable sieving retention for fluorescent PSL beads compared to two-layer filter members (Samples #1-3). FIG. 2 also shows that Samples #5 and #6 have improved sieving retention for fluorescent PSL beads compared to a single-layer 3-nm UHMWPE membrane (Sample #4).

### Example 3

### Absorption of Gold Nanoparticles

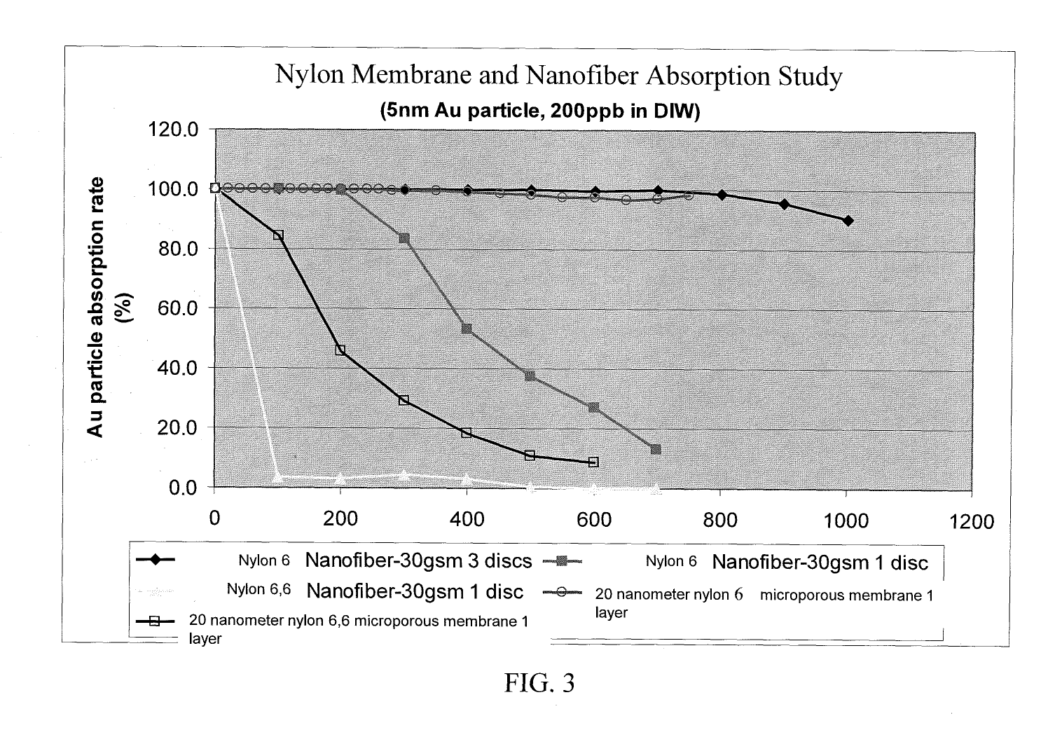

In this experiment, five filter members were challenged with a 200 ppb solution of 5-nm gold nanoparticles in DI water at a flow rate of 15 mL/minute. The gold nanoparticles were citrate-stabilized and were used to represent gels. The percent of gold particle absorption was measured as a function of volume of liquid (in mL). The results are depicted in FIG. 3.

FIG. 3 shows that a nylon 6 nanofiber layer or disc (1 layer is 1 disc of a 47-millimeter diameter sample) is better than a nylon 6,6 nanofiber layer at absorbing 5 nanometer gold nanoparticles at a concentration of 200 parts per billion by weight in deionized water. The increased absorption of the nylon 6 nanofiber layer compared to the nylon 6,6 nanofiber layer is likely due to increased non-sieving retention in the nylon 6 nanofiber layer. FIG. 3 also shows that a filter member including three layers of nylon 6 nanofiber at 30 grams per meter squared basis weight has nearly four times greater absorption than the single layer of nylon 6 nanofiber. In addition, the 20 nanometer pore size rated microporous membrane of nylon 6 has much better absorption for the gold particles than the 20 nanometer pore size rated microporous membrane of nylon 6,6. Based on FIG. 3, it appears that three discs of the nylon 6 nanofiber and a layer of 20 nanometer nylon 6 membrane would have very high absorption of 5 nanometer gold particles.

### Example 4

### Absorption of Phthalic Acid

The absorption properties of nylon 6, nylon 6,6 and UPE materials for part per million levels of phthalic acid in deionized water were also tested. Part per million levels of phthalic acid in water were passed through the filter members and the amount of phthalic acid downstream of the sample was detected and measured (y-axis). A higher y-axis value means that more phthalic acid passed through the sample and that less phthalic acid was absorbed by the sample. The graph shows that the nylon 6 microporous membranes absorbed more phthalic acid than the nylon 6,6 microporous membrane (both membrane were 20-nm size rated materials) and that both nylon microporous membranes absorbed more phthalic acid than the nylon nanofiber filter members. The results also showed that as the number of nylon 6 nanofiber layers is increased, the amount of phthalic acid that passed through the samples decreased. The results also showed that, on average, all of the nylon membranes absorbed more phthalic acid than the UPE macroporous membrane.

Although the present invention has been described in considerable detail with reference to certain embodiments thereof, other versions are possible. Therefore the spirit and scope of the appended claims should not be limited to the description and the versions contain within this specification.

What is claimed is:

1. A filtration member, comprising:
a non-sieving membrane layer having a pore size rating of between about 10 nanometers and about 50 nanometers;
a sieving membrane layer having a pore size rating of between about 2 nanometers and about 50 nanometers; and
a nylon nanofiber layer having a pore size rating greater than the pore size rating of the non-sieving membrane and sieving membrane layers, a basis weight of between about 20 grams per square meter and about 35 grams per square meter and a mean isopropyl alcohol (IPA) bubble point of between about 3.5 pounds per square inch and about 5 pounds per square inch.

2. The filtration member of claim 1, wherein the nylon nanofiber layer is interposed between the non-sieving membrane layer and the sieving membrane layer.

3. The filtration member of claim 1, wherein the non-sieving membrane layer is interposed between the sieving membrane layer and the nylon nanofiber layer.

4. The filtration member of claim 1, wherein the sieving membrane layer is interposed between the non-sieving membrane layer and the nylon nanofiber layer.

5. The filtration member of claim 1, further comprising one or more layers of a porous support material.

6. The filtration member of claim 1, wherein the filtration member has an upstream end and a downstream end and the non-sieving membrane layer, the sieving membrane layer and the nylon nanofiber layer are arranged to form an upstream retentive layer, a center retentive layer and a downstream retentive layer, wherein the nylon nanofiber layer does not form the downstream retentive layer.

7. The filtration member of claim 6, wherein the nylon nanofiber layer forms the upstream retentive layer.

8. The filtration member of claim 6, wherein the sieving membrane layer forms the downstream retentive layer.

9. The filtration member of claim 8, wherein the non-sieving membrane layer forms the upstream retentive layer and the nylon nanofiber layer forms the center retentive layer.

10. The filtration member of claim 8, wherein the non-sieving membrane layer forms the center retentive layer and the nylon nanofiber layer forms the upstream retentive layer.

11. The filtration member of claim 6, wherein the sieving membrane layer forms the upstream retentive layer.

12. The filtration member of claim 1, wherein the non-sieving membrane layer is a nylon membrane layer.

13. The filtration member of claim 12, wherein the nylon membrane layer and the nylon nanofiber layer each include nylon-6.

14. The filtration member of claim 1, wherein the filtration member comprises at least one nylon nanofiber layer.

15. The filtration member of claim 14, wherein the filtration member comprises three nylon nanofiber layers.

16. The filtration member of claim 1, wherein the sieving membrane layer is an ultra-high molecular weight polyethylene (UPE) membrane layer.

17. The filtration member of claim 1, wherein the sieving membrane layer is a UPE membrane layer and the non-sieving membrane layer is a nylon membrane layer.

18. The filtration member of claim 17, wherein the nylon membrane layer has a pore size rating of about 10 nanometers and the UPE membrane layer has a pore size rating of about 50 nanometers.

19. The filtration member of claim 17, wherein the nylon membrane layer has a pore size rating of about 50 nanometers and the UPE membrane layer has a pore size rating of about 2 to about 5 nanometers.

20. A filter, comprising a housing and the filtration member from any one of claims 1-19.

21. Use of the filtration member of any one of claims 1-19 or the filter of claim 20 to remove gel from photoresist.

22. A method of removing gel from photoresist, the method comprising passing a flow of photoresist through the filtration member of any one of claims 1-19 or the filter of claim 20, thereby removing gel from the photoresist.
